(19) United States
(12) Patent Application Publication
(10) Pub. No.: US 2024/0238138 A1
(43) Pub. Date: Jul. 18, 2024

(54) APPARATUS AND METHOD FOR PROPORTIONAL CONTROL OF POWER WHEELCHAIR OR MOBILITY DEVICE

(71) Applicant: Magitek, LLC, Hamilton, IN (US)

(72) Inventors: John L. Lautzenhiser, Hamilton, IN (US); Stephen Lautzenhiser, Hamilton, IN (US)

(73) Assignee: Magitek, LLC, Hamilton, IN (US)

(21) Appl. No.: 18/366,661

(22) Filed: Aug. 7, 2023

Related U.S. Application Data
(60) Provisional application No. 63/474,277, filed on Aug. 5, 2022.

(51) Int. Cl. A61G 5/10; A61G 5/04; A61G 5/12; B60K 26/02

(52) U.S. Cl. CPC A61G 5/1051; A61G 5/04; A61G 5/121; B60K 26/02; A61G 2203/18; A61G 2203/32; B60K 2026/025

(57) ABSTRACT

The present invention provides a control apparatus and system and method for operating a power wheel chair, the method comprising: a) providing an array of force-sensitive transducers adapted to provide proportional outputs in response to a detected force, the array comprising at least one forward force-sensitive transducer configured to provide a forward signal, at least one reverse force-sensitive transducers configured to provide a reverse signal, a left turn force-sensitive transducer and a right turn force-sensitive transducer; b) generating an output by array of force-sensitive transducers; c) receiving the output from the array at a signal conditioning module; d) conditioning, by the signal conditioning module, the received output from the array; e) generating, by the signal conditioning module, a control output based at least in part on the received output from the array; f) receiving, at a power wheelchair controller, the control output signal; and h) operating, by the power wheelchair controller, at least one drive wheel of a power wheelchair based at least in part on the received control output.

### CROSS-REFERENCE TO RELATED APPLICATION

This application claims the benefit of U.S. Provisional Patent Application No. 63/474,277, filed Aug. 5, 2022, entitled PROPORTIONAL POWER WHEELCHAIR HEAD CONTROLLED SYSTEM, which is incorporated herein by reference in the entirety.

### BACKGROUND OF THE INVENTION

### Field of the Invention

The present invention relates generally to power wheelchair and power mobility devices and to controlling such devices. More particularly, the present invention relates to user manipulation of control apparatus to generate an output that is provided as an input, including as an alternative control input, to power wheelchair motor controller and drive systems. Such drive systems provide propelling force and operation to move the wheelchair in a controlled fashion to permit the user a degree of mobility.

### Description of the Related Art

In recent years there has been an increasing awareness of the importance of not only providing for the needs of a majority of mobility-impaired persons, but also providing versatile systems that enabling those individual with heightened needs to operate mobility devices, e.g., power wheelchairs, and to enable them to operate adjacent or integrated systems, e.g., seating systems and peripheral systems including computers, IoT (Internet of Things) related devices, such as may be connected to a local network, such as a home or work network used by the operator of the mobility device.

The prior art includes electrically-propelled wheelchairs in which control of start, stop, and steering has been achieved by manually-actuated X-Y transducers, commonly called “joysticks.” Other types of inputs or alternative control systems have been developed that provide alternative input systems to essentially duplicate the traditional operational aspects of joysticks. For instance, individuals without beneficial use of their hands or arms require alternative man-machine interface equipment to allow them to effectively control operation of power wheelchair devices.

Lautzenhiser et al., in U.S. Pat. No. 4,906,906, issued 6 Mar. 1990, and in U.S. Pat. No. 4,978,899, issued 18 Dec. 1990, teach wheelchairs that are propelled by pulse-width-modulated voltages, that are dynamically braked by shorting the motors, that are made freewheeling without the expense and complexity of a clutch, and in which tremor control is provided, so that those who have hand tremors can easily and accurately control power wheelchairs.

The prior art includes attempts to control wheelchairs by sipping or puffing on a tube. However, controllability of sip-and-puff units has been marginal, especially for those who depend upon a respirator or ventilator for breathing, since they can puff into a tube only while exhaling, and sipping is even more difficult.

In U.S. Pat. No. 5,270,624, which issued on Dec. 14, 1993, Lautzenhiser teaches apparatus and method for adjustably minimizing variations of speed of a power wheelchair that ordinarily result from changes in motor torque caused by variations in grade, resilience of floor material, and/or roughness of terrain.

In U.S. Pat. No. 5,635,807, which issued on 3 Jun. 1997, Lautzenhiser teaches electric control systems that provide nonlinear relationships between X-Y mechanical inputs and resultant differential speeds of two propulsion motors. These nonlinear relationships between X-Y mechanical inputs and electrical outputs allow many handicapped persons, who otherwise would be limited to sip-and-puff systems, to control a wheelchair by joystick movement.

Perhaps even more significantly, when a joystick is replaced with two tiny transducers or input devices that are mounted to a person's head, or to an other body member, these nonlinear relationships allow easy and accurate control of both speed and steering of power wheelchairs by means of body-component movements. For instance, a person who is paralyzed from the neck down can perform all control functions of an electrically propelled wheelchair except for connecting and disconnecting power to the system.

In U.S. Pat. No. 5,635,807, Lautzenhiser also provides adjustable transducer sensitivity, steering sensitivity control that is adjustable, selectively-adjustable signal limiting so that maximum speeds can be selectively adjusted, and overrange shutdown.

In U.S. Pat. No. 6,426,600, filed 10 Mar. 2001, Lautzenhiser et al. teach a tilt-axis X-Y input device that may be mounted to a body component, such as the head or a hand of a user, null compensators that automatically compensate for errors in attaching the X-Y input device to a head or other body component, a null-width generator that adjustably provides a neutral zone to help an operator find and hold a neutral position, a turn-signal conditioner that provides easier control of turns including elimination of “fishtailing,” tremor control for those with body tremors, adjustable tilt-axis sensitivity to selectively match the motor skills of the user, and overrange shutdown as a safety feature.

U.S. Pat. No. 6,426,600, which is incorporated herein by reference in its entirety, Lautzenhiser teaches a system and method wherein an apparatus, such as a wheelchair is proportionally controlled by output signals produced by an X-Y input device, which may be attached to head, a hand or some other body component, and which may be actuated by tilting; the output signals are conditioned prior to application to the wheelchair; an apparatus for conditioning the output signals comprising a transistor sensitivity control, a transducer sensitivity adjustment a signal limiting control, a signal limiting adjustment, a null offset device, or null-width generator, a rate-of-change controller, a turn signal conditioner, or steering sensitivity control, a steering sensitivity adjustment, a nonlinear device that functions as a steering sensitivity control, a nonlinearity adjustment that functions as a steering sensitivity adjustment, and a microprocessor that may be used to perform some, or all, of the aforesaid functions.

In U.S. patent application Ser. No. 10/352,346, filed Jan. 27, 2003, now abandoned, but hereby incorporated in the entirety into the present patent application, Lautzenhiser teaches a tilt X-Y transducer that may be mounted to a body component, such as the head or a hand of a user; an automatic nulling device; an adjustable null width that does not attenuate an electrical signal; a turn-signal conditioner that provides easier control of turns and elimination of “fishtailing”; adjustable tilt-axis sensitivity to selectively match the motor skills of the user; control of a second device, such as a computer or an environmental control unit (ECU); and use of voice-recognition technology to provide various switching operations.

Finally, in U.S. patent application Ser. No. 09/801,201, which was filed on Mar. 7, 2001, also hereby incorporated in the entirety into the present patent application, Lautzenhiser et al. teach head, or body-member, control of apparatus in which electrical signals from mechanical-to-electrical transducers provide proportional control, and rate-of-change electrical signals of the same transducers control switching operations of such devices as computers or ECU's.

In the same patent, Lautzenhiser et al. teach control of a second device, such as a computer and its cursor, both of which may utilize voice-recognition technology to provide the required switching functions. In U.S. Pat. No. 9,019,205, filed 14 Nov. 2006, Lautzenhiser et al. teach a tilt-axis X-Y input device for computer and cursor control.

Even with the great strides that have been provided by head and other body-component control of both speed and turns of power wheelchairs, much still needs to be accomplished. Many still are unable to control their own safety except by the use of a call button. Many are unable to control their own comfort and productivity needs, such as adjusting leg supports, head supports, backrests, heating, cooling, and lighting. And many are unable to control productivity devices, such as computers, and entertainment devices, such as radio or television.

In the industry, apparatus for controlling safety, productivity, comfort, and entertainment devices have been called “Environmental Control Units” (ECU). Therefore, this terminology is used extensively in the detailed description.

Furthermore, there are many individuals whose condition has left them unable to operate a power wheelchair using normal control methods. These individuals may have very limited control over their head and other body-member. For these individuals, using their head or single body-member to control both X and Y movement may be difficult or impossible. What is needed is a control method to enable individuals with extremely limited physical ability to control a power wheelchair or ECU using only a single range of motion in their head or other body-member.

Alternative methods for controlling a power wheelchair, without a hand operated joystick, include chin joysticks, eye-gaze systems, fixed head arrays, hybrid head arrays, mini joysticks, sip and puff systems and emerging lower extremity input arrays.

However, need remains as there are too many severely disabled individuals who are unable to operate the above listed systems reliably and successfully.

### BRIEF SUMMARY OF THE INVENTION

The present invention provides an alternative to existing alternative control systems to enable severely disabled individuals a useful system for operating power wheelchair devices. While the primary use of the present invention control apparatus is to operate power wheelchair to provide safe and effective mobility, the system may also control other related systems, e.g., seating control, computer/cursor systems. For example, the present invention may be configured to allow physically-handicapped persons to control such things as wheelchair and hospital bed positioning actuators, lighting, entertainment, communication, computer and productivity devices.

In one embodiment, the present invention provides analog-type devices, such as one or more of Force Sensitive (or Force-Sensing) Resistors (FSRs), which may also be in combination with mechanical or proximity switches, to simulate the operation of a joystick. FSRs are typically material whose resistance (typically measured in ohms) changes when a force, pressure or mechanical stress is applied to the material. The FSR may provide a switching action or may be proportional and provide a variable value as an output based on the amount of force or pressure or stress applied.

The FSRs act as transducers, just as a typical joystick, to generate and deliver a proportional control signal, or a representative signal, to a power wheelchair control module. In essence, the input normally or typically connected to a joystick is instead connected to a signal conditioning module connected to the FSR sensor array. Although discussed herein in the analog domain, it is understood and appreciated that some or all or of the componentry described herein may be in the digital domain. Discrete elements are used in conditioning the signals generated by the FSR array, but any number of digital components may be used. If an input position of a mechanical-to-electrical transducer is “y,” then the output is equal to f(y) and also an input position of a mechanical-to-electrical transducer is “x,” then the output is equal to f(x). The signal conditioning module may be configured to generate a desired output based on the intended operation of the power wheelchair controller. Analog to digital (A/D) converters may be used to convert an analog signal generated by the FSR array into a useful digital signal for input into the control module. This is merely a design consideration and is not essential to benefit and enjoyment of the present invention.

In a first embodiment, the invention provides a method for operating a power wheel chair, the method comprising: a) providing an array of force-sensitive transducers adapted to provide proportional outputs in response to a detected force, the array comprising at least one forward force-sensitive transducer configured to provide a forward signal, at least one reverse force-sensitive transducers configured to provide a reverse signal, a left turn force-sensitive transducer and a right turn force-sensitive transducer; b) generating an output by array of force-sensitive transducers; c) receiving the output from the array at a signal conditioning module; d) conditioning, by the signal conditioning module, the received output from the array; e) generating, by the signal conditioning module, a control output based at least in part on the received output from the array; f) receiving, at a power wheelchair controller, the control output signal; and h) operating, by the power wheelchair controller, at least one drive wheel of a power wheelchair based at least in part on the received control output.

The first embodiment may be further characterized in one or more of the following manners: further comprising placing the array of force-sensitive transducers at a headrest of a seat of the power wheelchair; further comprising operating at least two adjacent force-sensitive transducers of the array of force-sensitive transducers and generating proportional signals from the activated force-sensitive transducers for input into the signal conditioning module simultaneously; further comprising placing one reverse force-sensitive transducer at opposite ends of the forward and turn force-sensitive transducers to emulate joystick forward, turn and reverse signal outputs associated with a conventional power wheelchair operation; wherein directional control of the power chair is achieved by the user's head rotating clockwise or counterclockwise while applying various amounts of force against the array of force-sensitive transducers; further comprising detecting “bumps” against at least one force-sensitive transducer and generating a “bump signal”, detecting the “bumps signal” within the signal conditioning module, and outputting switched signals that emulate a mode switch; further comprising generating a switched signal by the signal conditioning module and using the generated switched signal to toggle the power wheelchair controller from active state to sleep state and back to active state when driving is desired; wherein at least one force-sensitive transducer of the array of force-sensitive transducers is individually connected to a signal conditioning module that provides a fixed neutral or dead band signal to the wheelchair's drive control system that emulates a centered joystick; wherein at least one force-sensitive transducer of the array of force-sensitive transducers is individually connected to a signal conditioning module that provides an adjustable neutral zone or deadband that emulates an adjustable neutral zone or deadband associated with a centered joystick; wherein at least one force-sensitive transducer of the array of force-sensitive transducers is individually connected to a signal conditioning module capable of adding varying amounts of reverse signal to clockwise and/or counterclockwise pivotal turns, resulting in the power wheelchair moving rearward while performing pivotal turns in either direction.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a block diagram of a first embodiment of the present invention illustrating an FSR array including bump switch features included with Reverse FSRs in connection with signal conditioning control circuitry that may be either or both of analog or digital components;

FIG. 2 is a block diagram of a second embodiment of the present invention illustrating an FSR array including bump switch features included with Reverse FSRs in connection with signal conditioning control circuitry that may be either or both of analog or digital components;

FIG. 3 is a block diagram of a third embodiment of the present invention illustrating an FSR array including bump switch features included with Reverse FSRs in connection with signal conditioning control circuitry that may be either or both of analog or digital components;

FIG. 4 is a schematic drawing of toggle and electromechanical circuitry and interface that are part of the signal conditioning control circuitry of the embodiments of FIGS. 1-3;

FIG. 5 is a schematic drawing of the drive circuitry that is part of the signal conditioning control circuitry of the embodiments of FIGS. 1-3;

FIG. 6 is a schematic drawing of the bump switch circuitry that is part of the signal conditioning control circuitry of the embodiments of FIGS. 1-3;

FIG. 7 is a schematic drawing of a nine-pin plug and/or connector used in connection with the signal conditioning control circuitry of the embodiments of FIGS. 1-3;

FIG. 8 is a schematic drawing of the signal delay circuitry that is part of the signal conditioning control circuitry of the embodiments of FIGS. 1-3.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

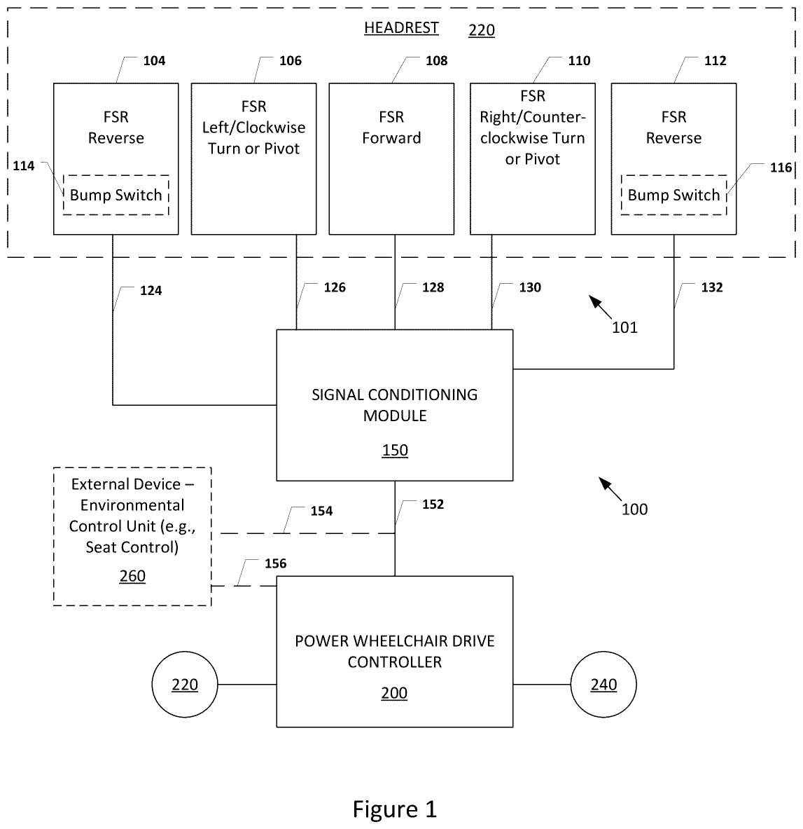

FIGS. 1-3 are block diagrams to illustrate three exemplary embodiments of the present invention showing functions and intercomponent relationships. For illustrative purposes only, the present invention is shown with three exemplary FSR array-based embodiments to provide control of a power wheelchair. FIGS. 1-3 illustrate how the respective FSR array components may be configured to be manipulated by a user to operate a power wheelchair (or other system). The three FSR arrays 101/102/103 each deliver control signals to a Signal Conditioning Module 150, which conditions the input signals to generate output signals configured as control inputs into a Power Wheelchair Drive Controller 200 and/or to an external device or Electronic Control Unit (ECU) 260. The Power Wheelchair Drive Controller 200 generates drive inputs to cause left wheel 220 and right wheel 240 to turn in a forward or reverse direction. As power wheelchairs do not have steering wheels or other means of directional guidance, the left/right drive wheels 220/240 are controlled to effect forward, reverse, turning (left/right) and pivoting (left/right) operation.

With reference to FIG. 1, Force Sensing Control Apparatus 100 comprises the FSR Array 101 electrically connected with a Signal Conditioning Module 150 by means of cables, tethers, wires or other suitable connecting means 124-132. Although the present invention is illustrated in wired fashion, it will be appreciated with wireless connections may be suitable for use in place of or along with wired connections. FSR Array 101 is comprised of FSRs 104, 106, 108, 110, and 112. Each FSR serves as an input transducer and transduces mechanical energy in the form of a user applying pressure by the back of his/her head onto the respective FSRs into an electrical signal as desired to generate an intended result, e.g., moving the wheelchair in a desired direction or manner. Although we describe for illustrative purposes the invention as used with FSR devices, the invention is not limited to FSRs.

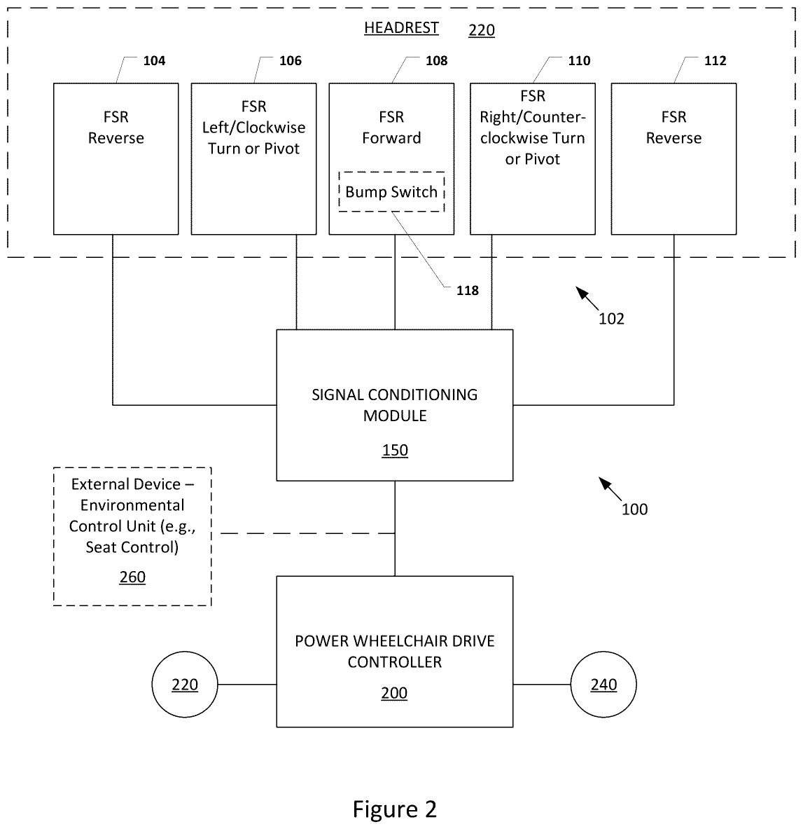

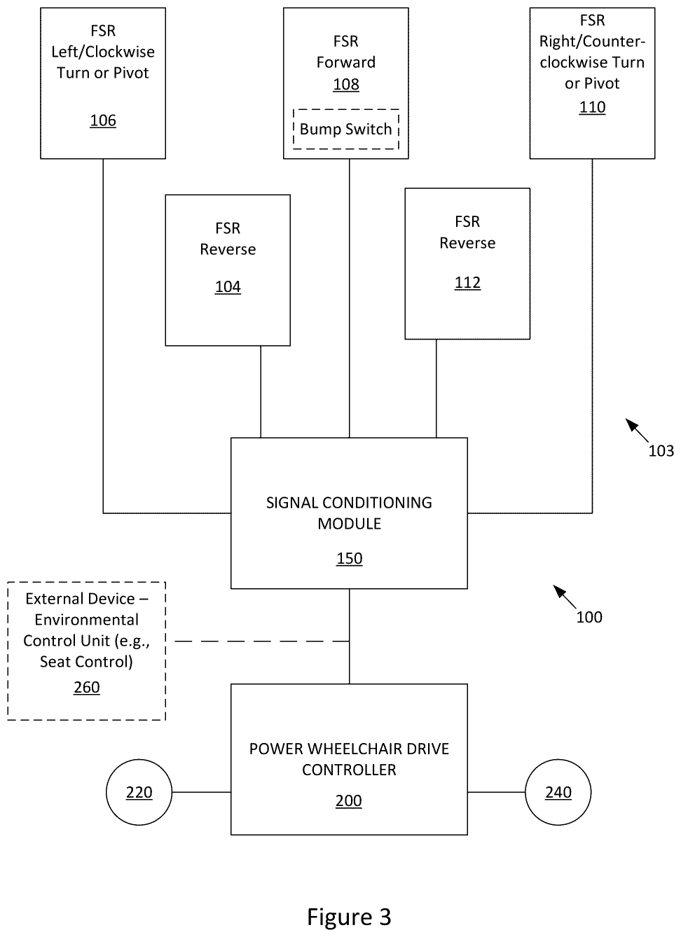

Benefits of using FSRs in the present application are they require uncomplicated control interface and are robust in demanding environments, such as daily use and constant contact with a user seated in a power wheelchair. FSRs are relatively thin (typically less than 0.5 mm) making them ideal for placement in the headrest, e.g., headrest 220, of a power wheelchair. The FSR array of FIGS. 1-2 may be affixed to the outside of a headrest, may be a slip cover type component that slips over a headrest, or may be included with the original OEM seat or incorporated and disposed inside the OEM headrest. Preferably, the FSR array may be adapted or fitted to provide an individualized approach to fit the needs of the individual user. The FSR array of FIG. 3 is shown in a “free form” or field adaptable form allowing the service technician or heath care professional place and adjust the locations of each FSR based on a trial and error approach. One alternative to FSRs are Force-sensing or “force-sensitive” capacitors (“FSC”), which are made of a material which changes capacitance when a force, pressure or mechanical stress is applied. It is somewhat of a design tradeoff in considering the use of FSRs vs. FSCs. Although FSCs provide improved sensitivity and repeatability compared to FSRs, they require more complicated drive electronics. Other types of force sensitive or force transducer devices include load cells that convert a force into an electrical signal that can be conditioned and serve as a drive signal. As a force applied to the load cell increases and decreases, the resulting electrical signal changes proportionally. A strain gauge is a type of load cell. Thus, when referring to a “force sensing” or “force sensitive” device herein, the invention is not limited to an FSR, but rather any effective device for sensing pressure or other force in performance of a user operating a power wheelchair may be used.

With reference to FIG. 1, the Signal Conditioning Module 150, which conditions the input signals to generate output signals configured as control inputs into a Power Wheelchair Drive Controller 200, may comprises a number of control features including, bump switch feature, a startup and delay feature, a null compensator feature, a turn control sensitivity feature, an external device interface feature, a voltage offset storer feature, and a wheelchair interface control feature. The Signal Conditioning Module 150 and its modules may comprise either analog or digital components. For example, the Signal Conditioning Module 150 may be either a microprocessor-based system or may be comprised of analog components such as op-amps, capacitors, resistors, and diodes for example and as described hereinbelow. In a microprocessor configuration, the Signal Conditioning Module 150 will also comprise a memory to store information needed for the operation of its constituent modules. In an analog configuration, the Signal Conditioning Module 150 would comprise a set of circuits and discrete components configured to condition an input signal from input FSR arrays to provide for control of powered wheelchair and/or external devices.

With reference now to the FSR Array 101 of FIG. 1, in this embodiment FSR Array 101 comprises a first Reverse FSR 104, a second Reverse FSR 112, a Left/Clockwise Turn or Pivot FSR 106, a Right/Counter-Clockwise Turn or Pivot FSR 110, and a Forward FSR 108. In this embodiment, both Reverse FSRs 104 and 112 include a bump switch feature as processed by the Signal Conditioning Module 150.

In typical operation, power wheelchair control systems, such as Power Wheelchair Drive Controller 200, require two individual electronic signals for the operation of the wheelchair. Commonly, the two signals are divided into a drive signal (forward and reverse) and a turn signal (left and right). Although the drive signal may be referred to as the “speed” signal, often control circuitry is configured to prevent over speeding or dangerous turning at high speeds and may be a function of both drive and turn signals. In one example, one signal labeled “X”, as shown as the X-axis and may control the forward and reverse speeds of the power wheelchair. The other signal labeled “Y”, as shown as the Y-axis may control the turn speeds of the power wheelchair. The joystick operation is typically viewed as a “quadrant” or 360-degree mapping of X and Y signals as produced by mechanical positioning of the joystick lever. The FSR Array 101 essentially maps out control of the wheelchair to replicate or approximate the operation of a joystick.

For further understanding, an X+ signal normally indicates a power wheelchair's forward movement, an X− signal normally indicates a power wheelchair's rearward movement. A Y+ signal normally indicates a pivotal clockwise turn and a Y− signal normally indicates a counter-clockwise pivot turn.

To operate a power wheelchair equipped with this invention it is necessary to press the back of the user's head against one or more of the FSRs 104-112. Forward movement is achieved by applying pressure to the centered FSR 108. Steering is accomplished by the user rotating their head to the right or left while maintaining pressure against one or more FSRs 106/110, which add a turn signal component to the signal conditioned output signals supplied to the power wheelchair's electronic controller, e.g., Signal Conditioning Module 150 inputs into Power Wheelchair Drive Controller 200.

Applying pressure against either turn FSR 106 or 110 exclusively results in a pivotal turn. Applying pressure exclusively against either reverse FSR 104 pr 112 results in the rearward movement of the wheelchair. Increasing pressure applied to the FSRs results in proportionally stronger signals received at Signal Conditioning Module 150, which in turn results in stronger control signals delivered to Power Wheelchair Drive Controller 200, which results in stronger signals delivered to one or both of left/right drive wheels 220 and 240. Here “stronger” signal is used in the context of increased signals relative to null or neutral position. Thus, more physical force or pressure asserted on FSRs results in faster movements or other dynamic aspects of the power wheelchair.

Various amplitudes and combinations of the afore described signals may be inputted into the power wheelchair's control system, resulting in theoretically infinite, proportional control of the power wheelchair's performance.

This exemplary embodiment of the invention consists of five (5) Force Sensitive Resistors (FSR) which may be attached to a front side of a power wheelchair's headrest in a horizontal array. The FSRs are individually connected to a signal conditioning module. The modified signals, outputted by the signal conditioning module, are then connected to the power wheelchair's electronic controller by means of an interface cable, such as a nine-pin cable and connector or coupler.

One particular benefit of the present invention is to emulate any or all X, Y values or signals outputted by a conventional power wheelchair's joystick mechanism.

With this invention, the analog signals are proportional to the force applied to the FSRs and satisfy the speed and/or directional input signal parameters required by the power wheelchair's controller to operate a complex power wheelchair. Additionally these same signals can be utilized to control other actuators on the power wheelchair such as seat elevators, tilt and/or recline, leg rest elevators or peripheral devices such as environmental controls and mouse movers.

The primary purpose of the signal conditioning module is to receive individual signals from the five (5) FSRs and modify them to the parameters required by the power wheelchair's electronic controller. The signal conditioning module may also output switching signals, that emulate a mode switch. These switched outputs can transform the wheelchair's control system from an active state, into a sleep state, and return to an active state when driving is again desired.

In a preferred embodiment the five FSRs are arranged across the wheelchair's headrest in a specific order.

The FSR 108, located at the center of the array 101, provides a proportional signal that results in forward movements of the power wheelchair when force is applied. The greater the force applied to the FSR 108, the greater the drive signal generated by the Signal Conditioning Module 150, and the greater the drive signal generated by the Power Wheelchair Drive Controller 200 and delivered to one or both the drive wheels of the power chair.

The FSR 106 attached to the left of the centered FSR 108 supplies a signal that may result in a clockwise pivotal turn of the power chair when force is applied. The greater the force applied to the FSR, the faster the clockwise pivotal turn.

The FSR 110 attached to the right of the centered FSR supplies a signal that may result in a counterclockwise pivotal turn of the power chair when force is applied. The greater the force applied to the FSR, the faster the counter-wise pivotal turn.

Arranging the right and left turn FSRs 110/106 in this order results in the power wheelchair veering or turning to the right when the user's head, pressed against the FSRs, turns to the right and results in the power wheelchair veering or turning left when the user's head is rotated to the left while pressing against the FSRs. Of course, the orientation of the FSR as “left” or “right” and to “clockwise” and “counterclockwise” is relative and the intended result of turning left or right is the main reference.

The fourth and fifth FSR's 104 and 112 are attached beyond the respective ends of the three FSR array described above. The purpose of the reversing FSRs, attached at opposing ends of the three FSR array, is to provide a reverse signal to the power wheelchair's controller. The greater the force applied to the FSRs, the faster the power wheelchair's reverse speed.

Preferred power wheelchair's performance parameters, such as speeds and torque, may be achieved by adjusting performance settings on the power wheelchair's programmable controller.

With reference now to the FSR Array 102 of FIG. 2, in this embodiment FSR Array 102 is similar to Array 101 in that it comprises a first Reverse FSR 104, a second Reverse FSR 112, a Left/Clockwise Turn or Pivot FSR 106, a Right/Counter-Clockwise Turn or Pivot FSR 110, and a Forward FSR 108. In this embodiment, however, instead of both Reverse FSRs 104 and 112 including a bump switch feature, the center Forward FSR 108 includes the bump switch feature.

With reference now to the FSR Array 103 of FIG. 3, in this embodiment FSR Array 103 is similar to Array 102 in that it comprises a first Reverse FSR 104, a second Reverse FSR 112, a Left/Clockwise Turn or Pivot FSR 106, a Right/Counter-Clockwise Turn or Pivot FSR 110, and a Forward FSR 108, and the center Forward FSR 108 includes the bump switch feature. In this embodiment, however, the FSRs are not confined to the headrest and may be located on other parts of the power wheelchair more easily accessed by the user.

In all material respects, the Arrays 102 and 103, respectively, of FIGS. 2 and 3 operated as described above for the Array 101 of FIG. 1.

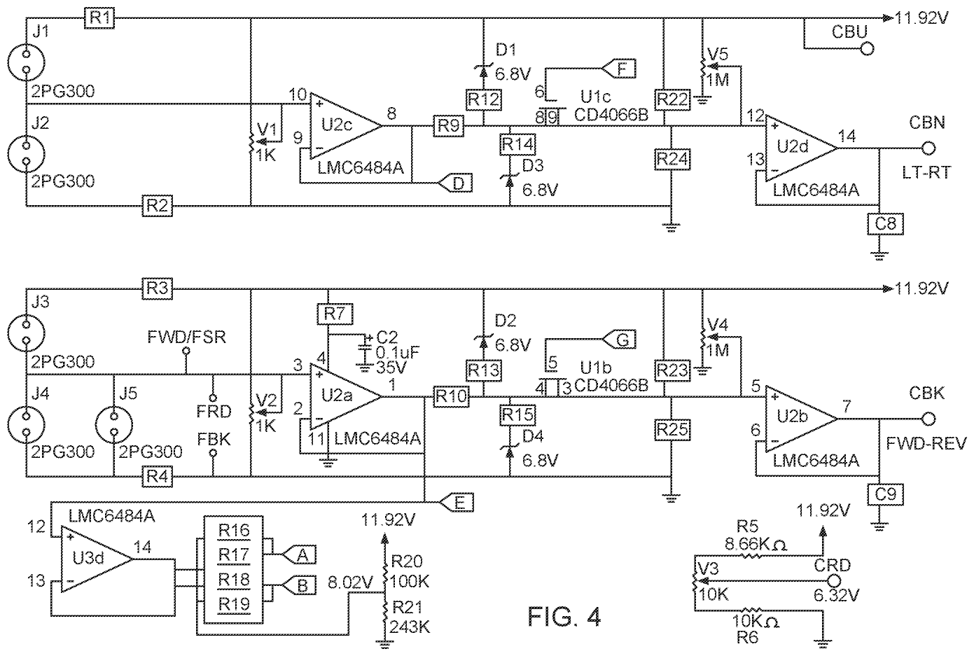

With reference now to FIGS. 4-8, a set of circuit diagrams are provided to illustrate an exemplary layout of the Signal Conditioning Module 150. In this set of schematic circuit diagrams, the Signal Conditioning Module 150 is configured and adapted to provide a nine-pin coupling with the input of the Power Wheelchair Drive Controller 200.

FIG. 4 is a schematic drawing of toggle and electromechanical circuitry and interface that are part of the Signal Conditioning Module 150 of the embodiments of FIGS. 1-3. A stereo-type jack and coupling is also used in connection with the Signal Conditioning Module 150 interface. For example, the optional stereo-jack feature allows an efficient way to control a “fob” or ancillary device, e.g., light on/off switch, TV on/off switch, or other binary operation. A “FOB” a small electronic device used typically in place of a key to unlock a door or start a vehicle or to remotely initiate the action of another device, e.g., a light or TV. For example, here the N-channel MOSFET transistor serves to toggle or “flip-flop” upon operation of the Forward FSR to generate a “chime” indicator (CH+/CH−) on fob use. In this example, EVT is connected to FOB “On” and EBL is connected to FOB “Off” and EGY/EGN are common for both FOB on and off. In one manner of operation, upon a user bumping the Forward FSR 108 once the system activates a menu associated with the power wheelchair. Two bumps may toggle the control system to turn on or off a light via the stereo/fob feature. A further bump can cause the system to transition to a standby state and a further bump can cause the system to go to a “sleep” mode. The system is versatile in that it may be set up so that the sequence of bumps can cause a number of desired operations. Bumping and then holding the Forward FSR 108 can enable the user to scroll through menu for selection operation by further “bumps.”

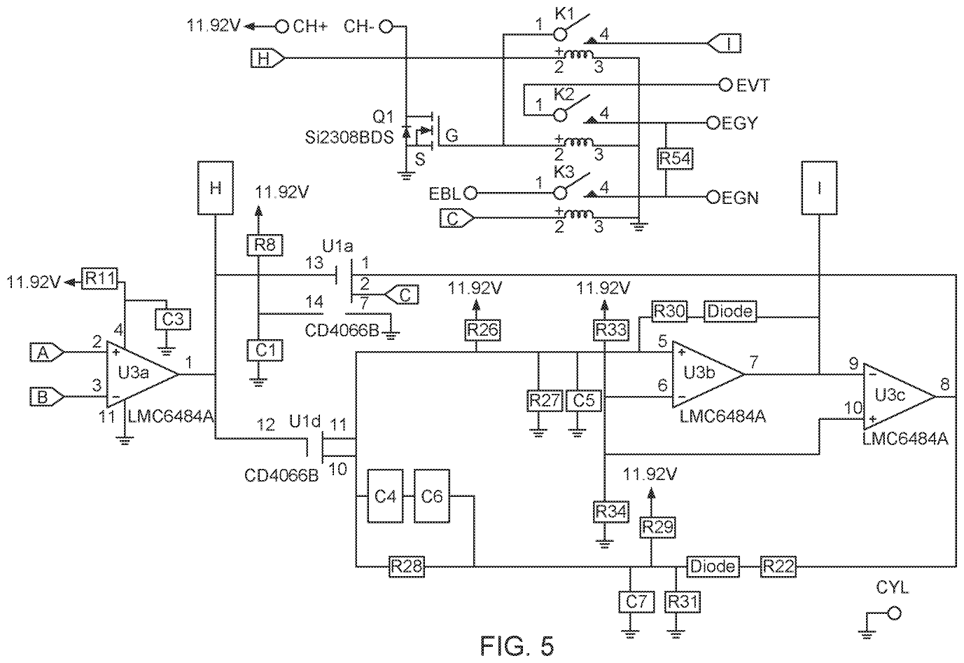

FIG. 5 is a schematic drawing of the drive circuitry that is part of the Signal Conditioning Module 150 of the embodiments of FIGS. 1-3.

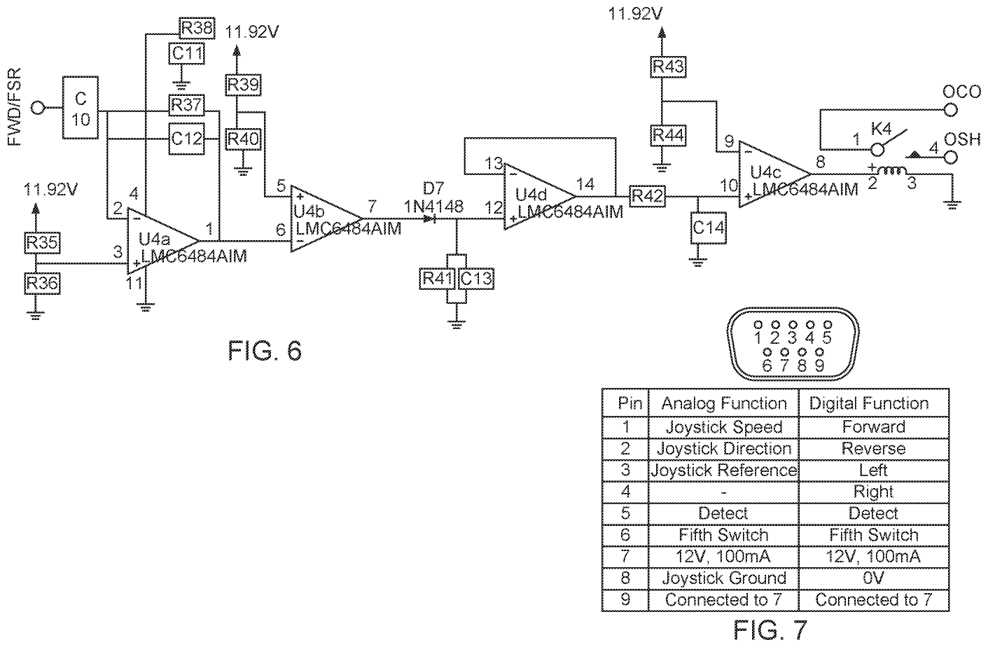

FIG. 6 is a schematic drawing of the bump switch circuitry that is part of the Signal Conditioning Module 150 of the embodiments of FIGS. 1-3.

FIG. 7 is a schematic drawing of a nine-pin plug and/or connector used in connection with coupling the Signal Conditioning Module 150 with the Power Wheelchair Drive Controller 200 of the embodiments of FIGS. 1-3. FIG. 7 provides a table of analog and corresponding digital functions to be aligned with the pin input of the Power Wheelchair Drive Controller 200. The particular pin configuration of FIG. 7 corresponds, for example, to the PG Drives Technology R-Net OMNI2 configuration. In this instance, Pin 1 corresponds to the CBK (FWD-REV) speed control node of FIG. 5; Pin 2 corresponds to the CBN (Left-Right) turn control node of FIG. 5; Pin 3 corresponds to the CRD reference shown in FIG. 5; Pins 4-6 are not used; Pins 7 and 9 correspond to the CBU supply voltage node of FIG. 5; and pin 8 corresponds to the FBK ground node of FIG. 5. In this manner of operation, the signal processing is based on a 50/50 voltage divider such that when the FSR is operationally pressed the FSR pull the centered (null) voltage up to approximately one volt above or below the null voltage. The signal delay provides a several millisecond delay so the OMNI2 controller, for example, needs to know for the bump switch to be consistently dependable.

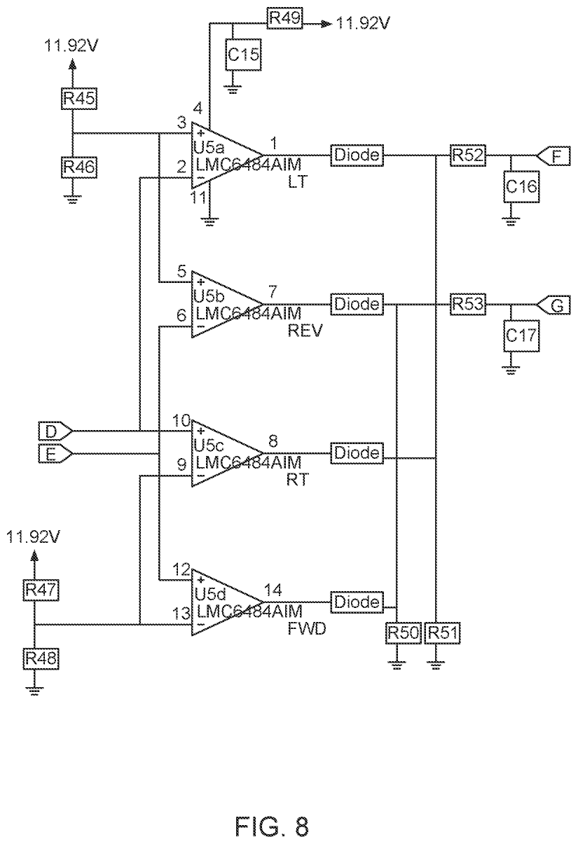

FIG. 8 is a schematic drawing of the signal delay circuitry that is part of the Signal Conditioning Module 150 of the embodiments of FIGS. 1-3.

The components of Signal Conditioning Module 150 shown in FIGS. 4-6 and 8 provide a nine-pin output wherein the pins A-I are shown at operative nodes of the Signal Conditioning Module 150 circuit. Power is delivered and regulated to ensure the circuit is properly powered. Various op-amps are shown, including part numbers, e.g., Additional discrete components, including diodes, resistors, varistors, capacitors and fuses are used. For example HE3621A1210 littlefuse speed relays, Diodes 1N4148 W-7-F, and op-amps LMC6484A.

While specific apparatus and method have been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims and their respective recitations.

What is claimed is:

1. A method for operating a power wheel chair, the method comprising:
a) providing an array of force-sensitive transducers adapted to provide proportional outputs in response to a detected force, the array comprising at least one forward force-sensitive transducer configured to provide a forward signal, at least one reverse force-sensitive transducers configured to provide a reverse signal, a left turn force-sensitive transducer and a right turn force-sensitive transducer;
b) generating an output by array of force-sensitive transducers;
c) receiving the output from the array at a signal conditioning module;
d) conditioning, by the signal conditioning module, the received output from the array;
e) generating, by the signal conditioning module, a control output based at least in part on the received output from the array;
f) receiving, at a power wheelchair controller, the control output signal; and
h) operating, by the power wheelchair controller, at least one drive wheel of a power wheelchair based at least in part on the received control output.

2. The method of claim 1 further comprising placing the array of force-sensitive transducers at a headrest of a seat of the power wheelchair.

3. The method of claim 1 further comprising operating at least two adjacent force-sensitive transducers of the array of force-sensitive transducers and generating proportional signals from the activated force-sensitive transducers for input into the signal conditioning module simultaneously.

4. The method of claim 1 further comprising placing one reverse force-sensitive transducer at opposite ends of the forward and turn force-sensitive transducers to emulate joystick forward, turn and reverse signal outputs associated with a conventional power wheelchair operation.

5. The method of claim 1 wherein directional control of the power chair is achieved by the user's head rotating clockwise or counterclockwise while applying various amounts of force against the array of force-sensitive transducers.

6. The method of claim 1 further comprising detecting “bumps” against at least one force-sensitive transducer and generating a “bump signal”, detecting the “bumps signal” within the signal conditioning module, and outputting switched signals that emulate a mode switch.

7. The method of claim 1 further comprising generating a switched signal by the signal conditioning module and using the generated switched signal to toggle the power wheelchair controller from active state to sleep state and back to active state when driving is desired.

8. The method of claim 1 wherein at least one force-sensitive transducer of the array of force-sensitive transducers is individually connected to a signal conditioning module that provides a fixed neutral or dead band signal to the wheelchair's drive control system that emulates a centered joystick.

9. The method of claim 1 wherein at least one force-sensitive transducer of the array of force-sensitive transducers is individually connected to a signal conditioning module that provides an adjustable neutral zone or deadband that emulates an adjustable neutral zone or deadband associated with a centered joystick.

10. The method of claim 1 wherein at least one force-sensitive transducer of the array of force-sensitive transducers is individually connected to a signal conditioning module capable of adding varying amounts of reverse signal to clockwise and/or counterclockwise pivotal turns, resulting in the power wheelchair moving rearward while performing pivotal turns in either direction.
